(19) United States
(12) Patent Application Publication
(10) Pub. No.: US 2026/0363253 A1
(43) Pub. Date: Nov. 19, 2026

(54) INTERMEDIATE BAKING PRODUCT

(71) Applicant: MEYERHANS MÜHLEN AG, Weinfelden (CH)

(72) Inventor: Dominic Meyerhans, Weinfelden (CH)

(21) Appl. No.: 19/475,768

(22) PCT Filed: Apr. 19, 2024
(86) PCT No.: PCT/EP2024/060821

§ 371 Date: Oct. 16, 2025

(30) Foreign Application Priority Data
Apr. 19, 2023 (CH) CH000411/2023

(51) Int. Cl. A21D 8/04; A21D 10/02

(52) U.S. Cl. CPC A21D 8/047; A21D 8/045; A21D 10/025

(57) ABSTRACT

An intermediate baking product includes a dough that is surrounded by a membrane which is aqueous and/or is water permeable. Furthermore, the intermediate baking product can include a liquid into which the dough with the membrane is partly or completely immersed. The dough can be a sourdough, and the membrane can have baking ingredients, and can be manufactured from gluten.

### BACKGROUND OF THE INVENTION

### Field of the Invention

The invention relates to an intermediate baking product, i.e. to a product which can be used for baking bread or the like, by way of it being added to flour and under certain circumstances to further ingredients. In particular, it relates to an intermediate product for baking sourdough bread.

### Description of Related Art

There are various possibilities for the manufacture of sourdough breads. The use of a so-called mother dough (also called “starter culture” or “pre-ferment”) from spontaneous sourdough which serves as a base dough provides particularly good results. The disadvantage is the considerable effort which must be undertaken for the preparation and the regular feeding (also called “refreshment”) of the mother dough. The creation of the dough before the actual baking process also requires much effort and is time-intensive. Furthermore, sourdoughs, in particular spontaneous sourdoughs as a rule need to be refreshed over several phases with much effort, before they can be applied with a high leavening. It is for all these reasons that inactive dry sourdoughs or dried, active sourdough cultures are often applied, such being obtainable ready for use. However, these do not even come close to non-dried spontaneous sourdough with regard to the leavening performance and the taste of the bread.

Retail-foodstuff-trade-purchased dry or liquid sourdough-(often also called sourdough extract) as a rule is microbially dead and merely has an aromatic and acidifying function, but no longer has any leavening power whatsoever. Yeast must always be added to these doughs as processed with this seasoning.

### SUMMARY OF THE INVENTION

It is therefore the object of the present invention to create an intermediate product for the creation of baking products which overcomes at least some of the disadvantages of the state of the art, is simple in its handling and successfully permits the creation of qualitatively high-value baking products.

This object is achieved by an intermediate baking product which includes a dough, in particular a sourdough. The dough is suitable as a leavening agent, i.e. it is suitable for triggering a fermentation process when it is mixed with flour and liquid. A leavening agent is necessary in order for the baking product (generally bread) to rise before baking and on baking. However, sourdough generally not only serves as a leavening agent, but also as an acidifying agent and aromatising agent. It also keeps the bread fresh, prevents mould and in particular renders rye flour capable of being baked via the acidification of the dough.

What is meant by the fact that the dough is suitable as a leavening agent is that it includes those lactic acid bacteria and yeasts which are necessary for the fermentation, as active microorganisms. I.e., for the activation of a fermentation process of the baking product dough (for example bread dough) one merely needs to add flour and possibly liquid—an addition of a further leavening agent, for example baker's yeast, although not being ruled out, is however not necessary. Wild yeast (which is extracted from so-called yeast water which is obtained for example from fruit) is an optional constituent of the dough, too.

The intermediate baking product is characterised in that the dough is surrounded by a membrane which is aqueous and/or is permeable to water. Apart from the characteristic of it being aqueous and/or permeable to water, the membrane can also have the characteristic of it being water-insoluble, thus not being able to be dissolved in water.

The intermediate baking product can furthermore include a liquid, into which the dough with the membrane is partly or completely immersed. This liquid keeps the membrane moist and can also regulate the moisture content of the dough and possibly further characteristics of the dough, for example its salt content.

The dough is thus not for instance packaged in a plastic foil, but in a membrane which permits the liquid exchange and which in embodiments for example can also permit a certain gas exchange with the surroundings.

The intermediate baking product's dough that is suitable as a leavening agent can be completely enclosed by the membrane—as a single portion, or also if it is subdivided into a plurality of portions.

It is also possible for the intermediate baking product to include several—for example two—portions which are each enclosed by a membrane and which include doughs of a different nature, wherein at least one of the doughs is suitable as a leavening agent. This can permit an optimisation of the finally arising baking product, also with regard to the taste.

The intermediate baking product's dough that is suitable as a leavening agent in particular can be a sourdough. Such, apart from flour and water, includes a culture of lactic acid bacteria and yeasts. The homo-fermentative (lactic acid forming) and hetero-fermentative (lactic acid and acetic acid forming) lactic acid bacteria and possibly also acetic acid bacteria effect a fermentation, by way of which lactic acid and possibly also (in smaller quantities) acetic acid arises. The pH-value of the sourdough generally lies between 3 and 5, in particular at a value of at least 3.2 or at least 3.5 or at least 3.8 and at the most 4.4 or 4.3, for example between 4 and 4.2.

The ratio of flour to water can vary greatly in a sourdough and can for example vary from 100:40 (flour: water) which corresponds to a dough yield (DY) of DY 140, in an Italian Biga sourdough up to 100:120, thus a DY 220 for example in highly hydratised sourdoughs. Sourdough breads with a softer, finer crumb and a very mild taste can be created with the latter.

A quantity of up to 2.5% salt can be added to sourdoughs, in order to improve their characteristics.

The characteristics of the sourdough (acid content), apart from the water quantity can also be controlled via the single-stage or multi-stage processing at different temperatures.

Somewhat higher temperatures of for example 30-35 °C are ideal for the development of homo-fermentative bacteria, cooler temperatures of 20-27 °C for hetero-fermentative bacteria and temperatures around 25-26 °C for yeasts. Sourdoughs under a warm processing therefore have an emphasis on lactic acid and as a rule are milder than doughs which are accentuated by acetic acids and under a cooler processing.

Instead of a sourdough, the dough which is suitable as a leavening agent can also be a wild yeast dough. The approach according to the invention can also be meaningful for the production of a wild yeast baking product for example from yeast water.

As an addition, encapsulated flour can be added to the dough within the membrane, in particular the sourdough, the encapsulated flour dissolving slowly over time and thus continuously feeding the sourdough. A corresponding flour capsule in particular can be designed such that it slowly dissolves in the dough within the membrane. Embodiments with such a flour addition within the membrane, under circumstances can be suitable for an even longer storage. With such embodiments, the outer packaging in particular includes a valve, in order to compensate the excess pressure which arises during fermentation.

The intermediate baking product can be used for example as an all-in-one product, as a complete replacement or, for the acceleration of maturing of the dough, also as a partial replacement of, or addition to, brewer's yeast (Saccharomyces cerevisiae). It can optionally additionally contain the quantity of water and/or salt which is necessary in order to create the finished bread dough with the flour quantity which is defined in the usage recommendation.

Regarding fermentation tolerance, oven leavening, formation of taste and aroma, quality of crumb and crust, freshness preservation and digestibility, sourdough is superior to brewer's yeast. It is merely the necessary dough resting time which, as a rule and depending on the dosing, is longer given pure sourdough breads, but this corresponds to a significant trend in the baking branch and in home-baking.

Furthermore, in a group of embodiments and for the purpose of receiving the dough which is enclosed in the membrane, as well as the liquid, the intermediate baking product includes an outer water-impermeable packaging which contains the dough with the membrane as well as the liquid.

In embodiments, the contents of the outer packaging—this can be designed as a beaker with a lid or in the manner of a pouch or have any other nature which is suitable for the fluid-tight packaging of foodstuffs—consist exclusively of ingredients which can be used for baking. In particular, the ingredients can be present in precisely the quantity which is necessary for the baking.

The membrane itself can be designed such that it consists of at least one baking ingredient which can be used for example for the baking process. For example, it can be manufactured in particular from gluten, i.e. it includes gluten and consists for example of gluten with water (amid hydration or hydratisation, i.e. the water is bound without or with a chemical reaction; as is know per se, the water is bound with the gluten or is incorporated in the gluten so that a viscoplastic dough forms), possibly with added other baking ingredients such as for example a ground cereal product (flour, semolina, bran) and/or possibly salt.

“Gluten” is to be understood as the gluten protein mixture which is present in some cereal varieties and is extracted from these—in particular from wheat, or for example also from spelt or original spelt (‘Urdinkel’)—and which forms a three-dimensional elastic structure by way of the addition of water. Gluten is an important constituent of most bread types by way of it forming the framework for the baking product and ensuring a gas retention capability for the carbon dioxide which is produced by the leavening agent—many doughs are only capable of being baked due to the gluten. Gluten can be obtained from wheat flour or other cereal flour types by way of suitable, in particular industrial separating processes. According to definition, concerning gluten it is a mixture of glutenins and prolamins (prolamins of wheat are called gliadines). Gluten with water (hydratised gluten) is elastically deformable and forms a stable membrane. Tests have found that in a reliable manner and over several days, it prevents the constituents of the dough which is surrounded by the membrane from dissolving into the liquid which surrounds the membrane.

In embodiments, the membrane includes wheat gluten as well as spelt gluten and/or original spelt gluten. The selection of the mixing ratio has an influence on the mechanical and rheological characteristics of the membrane.

The gluten for the creation of the membrane can also be divided in a targeted manner into gliadines (prolamin fraction) and “glutenins” (glutenin fraction) and these fractions can be mixed again in a ratio which is suitable for the membrane formation and which differs from the naturally occurring composition.

It is also possible to slightly ferment the gluten-water mass (the gluten “dough”) by way of the addition of a sourdough, before the membrane is formed therefrom. The fermentation—similarly to the composition—permits a control of the rheological characteristics.

As an alternative to gluten or as a supplement thereto (for example as an admixture to gluten), treated or untreated so-called wheat protein isolates (WPIs) are for example also possible as a constituent of the membrane. As with wheat gluten, these are wheat proteins. However, with a protein content of typically 90% they have an even high share of protein; concerning dry gluten the protein content in comparison to this is at least 75%, typically approx. 80%. A commercially obtainable wheat protein product is GemPro® Plus or GemPro® Prime-E of the Manildra group (USA).

Similarly to spelt gluten or original spelt gluten, the stretchability of the membrane can also be set by way of the admixing of WPIS.

Apart from the gluten—and possibly WPI—with water, the membrane can optionally contain further ingredients, for example a low quantity of flour (in a ratio of gluten to flour of for example at least 3:1 with respect to the mass). The addition of flour, although resulting in the membrane softening in the liquid, for example saltwater, somewhat more than without the addition of flour and/or partly reacting/fermenting with the dough in the membrane which can lead to an undesirable gas formation within the external packaging, the membrane however can be thicker given a defined maximal gluten quantity inherent of the recipe.

As a variant, one can ensure that the fermentation process of the gluten-flour-water mixture is already completed. For example, the membrane can be composed of mature sourdough with a high gluten content as well as a further addition of gluten and water.

As an alternative to a membrane of a baking ingredient, in particular of gluten or possibly WPI, the membrane can also be of such a nature that it is to be removed before the completion of the finished dough (i.e. of the dough which is to be baked). Thus, for example one can use a semi-permeable membrane of a material which needs to be removed. For example, one can use a semi-permeable membrane which permits the migration of flour constituents into the membrane by way of the concentration difference between the liquid and the sourdough. With the oxygen which is present in the membrane, the sourdough is herewith fed with flour in a continuous manner and depending on the diffusion speed over a longer time. The CO₂ which arises as a result could escape through the membrane and—via a valve—out of the outer packaging. In order to set the concentration difference, the flour can be linked to or encapsulated with salt—for example via extrusion.

The use of a membrane which contains no gluten can also be necessary in gluten-free intermediate baking products for the creation of gluten-free baking products on the basic of gluten-free sourdoughs.

In particular, the liquid can be a saltwater. On the one hand, saltwater provides a microbiological protection for the sourdough. One the other hand, the salt can stabilise the natural sourdough by way of it stemming the proliferation of yeast and thus preventing an excess ageing of the sourdough (cf. the so-called “Monheimer salt-sour process”). It solidifies and stabilises the membrane if this is made from gluten. It also ensures a particularly rapid cross-linking of the gluten, for example if the membrane is manufactured by way of the dough being brought into the suitable shape, then being coated with dry gluten power and subsequently being placed in the liquid, i.e., the saltwater. Yet a further advantage is the fact that salt is necessary in any case for the bread to be baked, the salt being able to be provided in the saltwater in the appropriate measure.

In particular, the salt content of the saltwater can be between 0% and 10% or between 1% and 5% or between 1.5% and 4%, especially between 2% and 3.5% or between 2% and 4%. The salt content is directed in particular towards the dough yield (water to flour) and towards the salt content of the dough. Typically, salt is added to flour with a dosing of 1.8-2.4%. For example, with at 165 DY (100 parts of flour to 65 parts of water), thus 375 g water (without taking the water in the membrane into account) per 500 g flour and 2.2% salt, a concentration of the saltwater of 2% *500 g/375 g=2.9% results.

Differing from a salt content between 0% and 10%, the saltwater can also be more highly concentrated and accordingly have less water, wherein a salt content of up to 25% or even more is possible. An intermediate baking product with a highly concentrated saltwater (brine) can be of particular interest if the weight is to be minimised and/or an addition of water for the creation of dough is considered in any case, for example if the baking product is a B2B product.

In embodiments, the liquid can be yeast water with or without salt. The yeast which is contained in the yeast water can further improve the leavening performance of the arising bread dough after the mixing with the dough suitable as the leavening agent and the flour.

In yet a further embodiment, apart from water, the liquid can include further constituents, for example flour. In particular, it is possible for the liquid itself to be a—very liquid—dough, for example a pre-dough or a sourdough with or without salt.

By way of the gluten membrane between the sourdough and the liquid, in particular saltwater, the saltwater and the sourdough are not mixed within the outer packaging (with the exception of a certain unavoidable diffusion through the membrane). This on the one hand simplifies the handling, since a natural sourdough is always semi-fluid and sticky, but is enveloped by the membrane. On the other hand, the shelf-life is improved. The fact that the sourdough and the saltwater are not mixed also means that the salt content of the saltwater remains high and the Ph-value of the sourdough low. Both are microbiologically advantageous. Given a later kneading of the dough, the membrane can distribute itself in the dough without residue and is hence already present as a gluten-water mass already at the beginning of the kneading, which is more rheological with regard to the dough and also advantageous with regard to the baking result. Since the membrane provides gluten to the flour for the later baking process and specifically with water which is bound thereto or incorporated therein, the intermediate baking product can generally be used together with untreated flour, i.e. without flour with the addition of dry gluten.

Apart from these effects, the liquid—possibly independently of its salt content—has the effect that it reliably prevents a drying out of the membrane.

A method for the manufacture of the intermediate baking product includes for example the following steps:
Natural fermentation of the sourdough on the basis of a pre-produced sourdough, for example with 5 parts of flour, 5 parts of water and one part of the pre-produced sourdough (as is known per se, a part of the sourdough can be used as a pre-produced sourdough (leavening agent) for the subsequent sourdough production);
Optionally: control of the fermentation via a determining of the Ph-value or of the degree of acidity of the sourdough;
Optionally: cooling of the sourdough, in order to extend the shelf-life before filling into the membrane;
Producing the membrane;
Filling the membrane with the sourdough;
Placing the sourdough with the membrane in the outer packaging together with the liquid, in particular saltwater;
Closing the outer packaging.

Herein, the used ingredients and/or subsequently the intermediate baking product can be cooled as a whole.

There are various possibilities for the manufacture of the gluten membrane. A first possibility is the extrusion amid the use of gluten dough (i.e. amid the use of gluten with water which is bound thereto or incorporated therein), for example with single-shaft or double-shaft extruders as well as a flat nozzle or ring nozzle.

For the filling, the extruded gluten membrane can be applied around the dough which is present in lump form.

As an alternative for the filling, as an option the sourdough can also be filled into the arising “gluten sheath” by way of co-extrusion given the use of ring nozzles, and this sheath can be closed in a portion-wise manner. In this case, the dough would be shaped by way of co-extrusion into the gluten membrane shaped by the ring nozzle of the extruder, and shaped into dough packets by way of a crimper. So-called pillow crimpers are common devices for this purpose and are usually arranged subsequently to the extruder in co-extrusion. The singularisation can however also be effected by way of other devices, for example by way of twisting off (cf. the end of a sausage) or cutting off, etc.

If the gluten membrane is produced as a flat layer—for example by way of extrusion with a flat nozzle or also by a spraying method (spraying with water and/or dry gluten) on a flat surface or by rolling out (inasmuch as the limited plasticity of gluten dough permits this), then a method as is known for example for the production of Swabian ravioli is also considered: the sourdough is deposited onto a first layer in portions and is then covered with a second layer, whereupon the first layer and the second layer are pressed onto one another at the locations between the sourdough portions and the portions are simultaneously or subsequently separated from one another.

Yet one possibility lies in shaping the gluten dough and bloating it into a balloon-like formation by way of injection of the sourdough.

Yet a further possibility for the manufacture of the gluten membrane consist of a layering of the dough with powder-like gluten and the subsequent spraying with water.

The manufacture of dry gluten, as is commercially obtainable, includes a drying step which is relatively energy-intensive. Since gluten with water is used for the membrane, there is also the possibility of forgoing the drying step already when extracting the gluten and using the aqueous gluten—which on account of the reduced energy effort on extracting the gluten also represents an even more sustainable solution.

The use of non-dried gluten which is washed directly out of the dough which is manufactured from flour and water and possibly further ingredients, is not only advantageous for the manufacture of the membrane for reasons of sustainability. The characteristics of non-dried gluten can also be useful from a dough-rheological point of view and can positively influence the baking results.

Independently of this, the approach according to the invention also has the advantage that it permits a baking whilst forgoing baker's yeast which is obtained at a high energy cost and a high consumption of water. Furthermore, it is also possible for brine (i.e. saltwater which arises on extracting salt) to also be able to be used as saltwater instead of using dried salt, such also reducing the energy expense on extracting salt.

In particular, the intermediate baking product can be provided for the cooled storage, transport and/or shipping, for which purpose it can also be provided with a suitable notice (for example “store cooled”). In this context, the liquid entails the further advantage that it serves as a cooling buffer, i.e. it prevents the intermediate baking product from heating too greatly given unrefrigerated transport, for example from the supermarket into the refrigerator of the consumer.

In particular, one can envisage the user, apart from the intermediate baking product-which contains the liquid, in particular the saltwater-only having to add flour and possibly water, but no further ingredients, in order to obtain the baking product dough, for example bread dough. The intermediate baking product can include information-for example printed onto the outer packaging or a repackaging or connected to the intermediate baking product in another manner-which instructs the consumer and includes details on the ingredients which are yet to be added, for example the nature and the quantity of the flour to be added, or markings for additional water quantities to be added for the creation of softer doughs, i.e., doughs with greater dough yields.

In embodiments, the intermediate baking product can be envisaged specifically for the preparation of a certain baking product—for example a light or dark wheat sourdough bread, a rye-wheat bread, a spelt sourdough bread, sourdough croissants, etc.—to which the information correspondingly refers.

In embodiments, the intermediate baking product can also be part of a baking set which apart from the intermediate baking product also includes the flour of the required nature and quantity, as well as possible further ingredients—i.e. the invention also relates to a baking set with the intermediate baking product as well as suitably packaged flour. Herein, the flour can be present as normal flour or special flour in the context of the regulations (Switzerland) of the EDI on cereals, pulses, plant proteins and their products (dated: 1st April 2023), and/or it can be present as a constituent of a so-called baking mixture, wherein a baking mixture represents a flour which is enriched with further ingredients, or other cereal product. In general, flour according to the presently used terminology is the product which arises on finely grinding cereals grain or pseudo-cereal types or pulses; other starch-containing powders which are suitable for the preparation of baking products are also considered. A baking set of the type which is described here can be configured for example such that the flour at least partly surrounds and insulates the intermediate baking product, such rendering it particularly suitable for the mail-order trade.

The liquid quantity can be matched to the quantity of the dough as well as the quantity of flour which is to be added, so that water also does not need to be added. If this is not the case, i.e. if the liquid quantity is too small for the bread dough, or moist dough is desired, and if the outer packaging is dimensionally stable, for example is present as a beaker-like packaging, then it can optionally include a marking. Such a marking can indicate to the user as to how much water can yet be added or needs to be added.

Supplementarily or alternatively to scale for water which is to be additionally added, the vessel can also include other markings. For example, the quantities which are provided in recipes and concerning which liquids other than water are added can be printed on. For example, for preparing a sourdough butter braid the user could be instructed for example to remove the intermediate baking product, pour away the saltwater and add milk in the quantity up to a dedicated marking. In this case, the salt would have to be supplemented manually. In a further example, the scale could be used to indicate to the user the quantity of dried fruit which needs to be added to the baking product dough according to the recipe.

In particular, one can envisage, apart from water, only those ingredients being contained in the outer packaging and/or possibly in the baking set which are approved for baking bread according to the relevant foodstuff regulations-for example the Swiss regulations of the EDI on foodstuffs of vegetable origin, mushrooms and table salt (VLpH), dated 1st of April 2023, in particular the paragraphs concerning cereal, starch-containing grain crops and granary products as well as concerning bread, or the regulations (Switzerland) of the EDI concerning cereals, pulses, plant proteins and their products (dated: 1st April 2023), said regulation containing a definition of normal flour, or according to relevant stipulations for the EU, in particular for Germany (dated: 1st April 2023).

For example, in embodiments, apart from normal flour and other flours as well as water, salt and if necessary baker's yeast, at most the following ingredients can be contained within the outer packaging: further cereal products such as gluten, wheat germ, enzyme-active malt flour, grains, possibly acerola powder or other natural foodstuff with a high content of ascorbic acid; as well as possibly grain crops and their products of plants which are not counted as being real cereal types (pseudo-cereals, for example buckwheat, quinoa, chia seeds, etc.), at most other natural foodstuffs such as dried fruit, nuts, dairy products, etc.

In particular, the contents of the outer packaging can consist only of foodstuffs (including salt, water), thus exclusively of substances which are suitable for consumption.

A further optional feature of the outer packaging is—depending on the nature of the contents of the outer packaging—a valve which permits the escape of gas, specifically carbon dioxide. This can be advantageous for example if the dough of the intermediate baking product can and should still continue to ferment during storage.

Apart from the dough with the membrane as well as liquid, in particular saltwater, the intermediate baking product can yet optionally include further constituents in the inside of the outer container. As such, in particular further ingredients for the dough to be created are considered, for example a soaker, a scald, a further pre-ferment, grains, groats, seeds, sugar, egg powder, milk powder, enzymes, etc.

The outer packaging of the intermediate baking product—in particular also for commercial use—can also be designed as a container in larger volumes (for example 5 litres) and as a reusable unit which can be stacked on pallets. This would be returned again to the producer of the intermediate baking product after emptying the intermediate baking product, washed there and refilled.

A further aspect of the present invention relates to the provision of a fermentation vessel (“fermentation box”). Since with regard to the natural sourdough it is the case of a natural product which over time is subjected to a certain breakdown of the leavening power (on account of the dying-away of the microorganisms due to lack of supply of nutrients and oxygen), the consumer can be provided with a fermentation vessel which given the use of a prescribed flour and a recipe (recipe x) indicates the appropriate fermentation(s). The fermentation vessel thus includes at least one marking, for example in the form of a specified region, up to which the dough must rise in the ideal case when—for the defined recipe—it has the ideal fermentation. In particular, the vessel can include several markings, for different recipes.

Also, even if the time period of the bulk fermentation is generally set by the recipe—i.e. the consumer is instructed to let the dough stand for a set fermentation time, for example 12 hours—the fermentation can be additionally examined by way of the use of the fermentation vessel and readjusted if necessary, for example if the intermediate baking product is already for example 20 days old or older-then the comparison with the markings in the fermentation vessel under certain circumstances results in the fermentation still not being optimal after the time which is envisaged in the recipe, and a fermentation time of more than 12 hours results if one waits until the marking is reached.

Such a fermentation vessel can serve as part of a baking set of the type which is described above. For example, it can form a set packaging which contains the intermediate baking product, apart from further constituents of the set such as flour and under certain circumstances further baking ingredients and/or information etc.

A fermentation vessel however can also be offered separately, for example as an optional supplementation of the intermediate baking product or as a fermentation vessel set together with information on the recipes, to which the markings refer.

Apart from the fermentation vessel, a fermentation vessel set also includes information on the recipes, in paper form, in the form of printed-on machine-readable codes which then refer to an internet site or an app, etc.

### BRIEF DESCRIPTION OF THE DRAWINGS

Embodiment examples of the invention are hereinafter described by way of drawings. In the drawing, the same reference numerals denote equal or analogous elements. The drawings show elements which partly correspond to one another in sizes which differ from figure to figure. There are shown in:

FIG. 1 an intermediate baking product;

FIG. 2 a baking set with an intermediate baking product; and

FIG. 3 a further intermediate baking product;

FIG. 4 a fermentation vessel;

FIG. 5 a further intermediate baking product; and

FIG. 6 a further baking set.

### DETAILED DESCRIPTION OF THE INVENTION

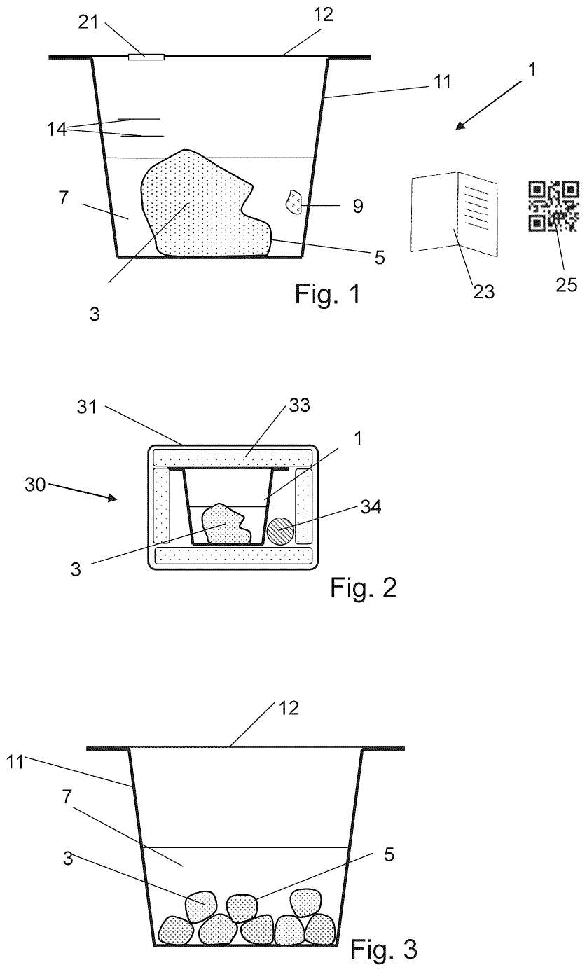

An example of an intermediate baking product 1 is represented in FIG. 1. The intermediate baking product 1 includes a sourdough 3 which is surrounded by a membrane 5 which completely encloses the sourdough 3, the membrane being of gluten with water which is bound thereto or incorporated therein. The intermediate baking product 1 further includes an outer, water-impermeable packaging which in the represented embodiment includes a beaker 11—alternatively a pouch would also be conceivable—and a lid 12 which closes the beaker for example is fixedly welded to this, or foil board. The outer packaging can be designed in the manner of packaging as is used for burrata, inasmuch as the consistency of the sourdough 3 in the membrane 5 can be similar to that of burrata.

However, the outer packaging can also have a different form or nature. For example, it can also be pouch-like and flexible, and/or it can be manufactured from a biodegradable material and/or a material of renewable raw materials. Conditions placed on the nature of the outer packaging include the need for water-impermeability as well as generally the demands as are placed on the packaging of cooled foodstuffs.

Apart from the sourdough 3 in the membrane 5, the outer packaging also includes saltwater 7 in which the sourdough 3 in the membrane 5 is at least partly submerged. Apart from this, optionally further ingredients 9 such as for example a soaker, a scold, a pre-ferment, possibly poolish, grains, seeds etc. can be present within the outer packaging.

In particular, the complete contents of the outer packaging, i.e. the complete intermediate baking product with the exception of the outer packaging-as well as the information, see subsequent description-can consist of baking ingredients which are approved for baking products.

Depending on the nature of the sourdough 3 and possibly of the optional further ingredients 9, a release of gas, in particular carbon dioxide can occur during storage of the intermediate baking product 1 on account of fermentation processes. If this is the case, then the outer packaging can include an—optional—valve 21 which permits gas to escape but allows no entry of air oxygen and possibly also no exit of water. Corresponding valves for foodstuff packaging as well as membranes which only permit a passage of gas but not a passage of liquid are known.

The intermediate baking product 1, apart from the outlined constituents can also contain information of its use, for example details on the quantity of flour to be added and possibly further ingredients, for preparing the finished dough (which apart from the sourdough 3, the gluten of the membrane 5 and the saltwater 7 as well as possibly the further ingredients 9 at least yet includes flour), on the recommended kneading time, working of the dough, dough stand time or fermentation time of the dough, processing of the dough before the baking as well as on the actual baking. Such information can be printed on the outer packaging or on a label which is fastened thereto, in the form of a separate information medium 23, or via a suitable for example printed-on link 25 can also be retrieved from an external electronic data source.

In the case that the saltwater forms no sufficient liquid quantity, or in the case that the intermediate baking product is suitable for the preparation of different doughs with a different liquid content, the outer packaging if it is designed in a dimensionally stable manner can optionally include markings 14 which indicate the quantity of the water and/or further ingredients which are yet to be added.

FIG. 2 shows a baking set 30 with the intermediate baking product 1 as well as with flour. In the represented embodiment example, the flour with its enveloping (for example of paper) forms wall segments 33 of a baking set package, the package including a baking set packaging 31, so that the baking set forms a compact packet, wherein the flour contributes to the thermal insulation of the intermediate baking product.

The baking set 30 as a whole can be suitable for the mail-order trade and can be sent to the final consumer.

In the represented embodiment example, the baking set 30 yet includes an optional cooling element 34. Such a cooling element in embodiment examples can be used by an end-consumer; for example water which is contained therein, initially for example as ice, can form a liquid addition for the completed dough if the liquid which is contained in the saltwater is not sufficient. A drinking water bottle is also conceivable as a cooling element 34.

FIG. 3 shows an alternative intermediate baking product in which the dough 3 (or the doughs in the case that several different doughs are used) is/are present in a manner divided into several portions. Each portion is completely surrounded by the membrane 5.

### Example: Sourdough Bread

Typically, the following ingredients are used for a dough of 500 g untreated flour (the percentage details relate to the flour quantity 500 g=100%, i.e., the percentages of all ingredients always add to above 100%):
65% water=325 g (55%-85% possible)
2% salt=10 g (1.5%-2.5% possible)
2% gluten=10 g (a dry gluten addition of 0-4% to the flour is common)
10% sourdough=50 g (the quantity of starter culture to flour can be up to 30% with wheat doughs, with rye doughs significantly higher)

10 g gluten is provided with a further 10 g of water for the creation of the membrane. Accordingly, in the example which is represented here, the intermediate baking product for a sourdough bread can include 500 g of flour, 50 g of sourdough in a 20 g membrane of gluten with water which is bound thereto or incorporated therein, surrounded by a saltwater of 325 g (+10 g of the membrane) water and 10 g salt (saltwater containing approx. 3% salt) . The outer package (for example a plastic vessel, for example beaker-like) therefore receives a volume of at least 400 ml (under the assumption that the density of the dough and membrane roughly corresponds to the density of water).

In a variant, the vessel can include markings (scale) for water which is to be additionally added, so that the dough, instead of including 65% water can also include—for example—68%, 72% or even 80% water (always with respect to the cereal quantity), which corresponds to an additional water quantity of 15 ml, 35 ml or 75 ml.

Of course, the intermediate baking product itself can already contain such an additional water quantity. Doughs with higher water additions as a rule maintain their freshness to an improved extent and have a coarser pore formation, which is desirable with sourdough bread, but renders the handling significantly more difficult.

Further examples of intermediate baking products are:
intermediate baking products for the creation of spelt bread or original spelt bread (i.e. the baking set possibly includes (pure) spelt flour), with a membrane of (pure) spelt gluten. Since the application of water roux or soakers is recommended with spelt bread, the dough or the saltwater can optionally include a pre-soaked or pre-scalded (thermally treated and thus slightly to completely pre-soaked) flour or grist.
Label products are also possible, for example intermediate baking products in organic quality, IP-Suisse quality or Suisse Garantie quality.
Intermediate baking products for the creation for example of sourdough butter braids or brioches or other baking products on the basis of sourdough with the addition of fat (the intermediate baking product and/or the baking set can contain egg yoke powder, sugar and/or butter and/or the consumer can be instructed to add these ingredients).
Intermediate baking products for the creation of pancakes or comparable baking products on the basis on sourdough (the intermediate baking product and/or the baking set can include egg yoke powder, sugar and/or butter and/or milk powder and/or baking powder and/or aroma (vanilla powder or the like and/or the consumer can be instructed to add these ingredients).

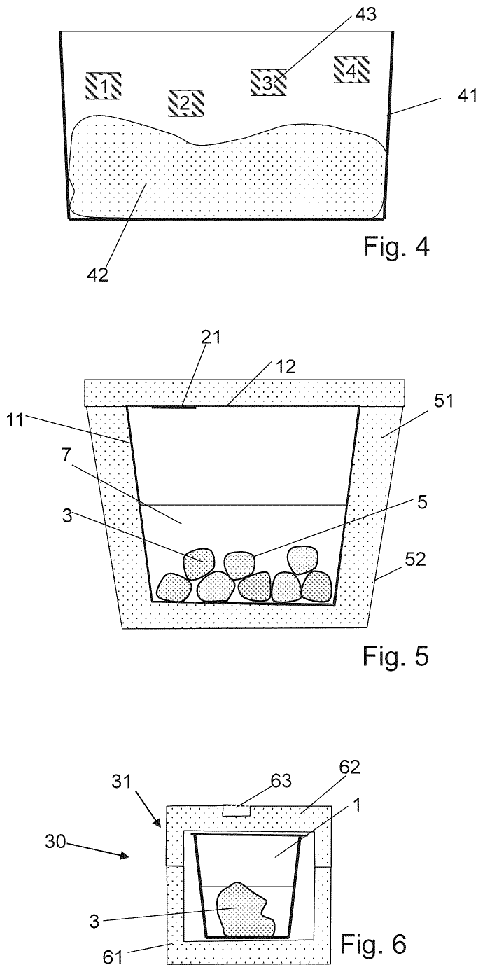

FIG. 4 shows a fermentation vessel 41 of the previously mentioned type. The fermentation vessel include a plurality of markings 43 which each indicate the ideal fermentation for recipes 1-4 by way of them indicating a region up to which the dough 42 which is present in the fermentation vessel 41 in the defined quantity is to rise. The dough 42 was previously produced by mixing the dough product 3 with a quantity which is matched thereto, of for example 500 g quality flour and—depending on circumstances—the saltwater, further liquid, salt and/or other ingredients.

FIG. 5 shows an embodiment, concerning which the outer packaging is composed of a plastic beaker 11 with a sealed lid 12 as well as an insulating envelope 51 of a wheat product as well as possibly an outer envelope 52 of paper, cardboard, a bio-composite material or a plastic.

FIG. 6 shows a further baking set 30 with the intermediate baking product as well as with flour. The baking set packaging 31 includes a first part-packaging 61 and a second part-packaging 62. The first part-packaging 61 can include a first flour composition (for example a certain wheat flour or rye flour or a mixture of various flours) and the second part-packaging 62 a second, under certain circumstances different flour composition (for example flour of another cereal type or with a different grinding fineness). One of the two part-packagings 61, 62 supplementarily or alternatively to this can include other baking ingredients, for example dried fruit and/or nuts or the like. Likewise represented is the possibility—independent of the multi-part nature of the baking set packaging 31—of providing a shaker 63 on the baking set packaging, the shaker being protected by a peel-off foil and from which for example flour can be scattered from the baking set packaging onto an underlay surface.

1. An intermediate baking product, comprising a dough and an aqueous and/or water permeable membrane, wherein the dough is suitable as a leavening agent and the aqueous and/or water permeable membrane surrounds the dough.

2. The intermediate baking product according to claim 1, further comprising a liquid in which the dough with the membrane is at least partly immersed.

3. The intermediate baking product according to claim 2, wherein the liquid is saltwater.

4. The intermediate baking product according to claim 3, wherein the saltwater has a salt content of between 0.5% and 25%, 10%.

5. The intermediate baking product according to claim 1, further comprising an outer packaging in which the dough with the membrane is contained.

6. The intermediate baking product according to claim 5, wherein the contents of the outer packaging exclusively consist of ingredients which can be used for baking.

7. The intermediate baking product according to claim 1, wherein the membrane consists of baking ingredients.

8. The intermediate baking product claim 1, wherein the membrane is manufactured of a gluten-water mixture.

9. The intermediate baking product according to claim 1, wherein the dough is a sourdough.

10. The intermediate baking product according to claim 9, wherein the pH-value of the dough is between 3 and 5.

11. The intermediate baking product according to claim 5, wherein the outer packaging comprises information on further ingredients which need to be added, in order to create, from the dough as well as the membrane and possibly further constituents of the intermediate baking product, a finished baking product dough for baking a baking product.

12. The intermediate baking product according to claim 11, wherein the outer packaging comprises a marking for measuring an additional amount of water to be added.

13. The intermediate baking product according to claim 11, wherein apart from contents of the outer packaging, only flour as well as optionally water needs to be added, in order to create the finished baking protect dough.

14. A baking set, comprising an intermediate baking product according to claim 1, as well as a flour and/or a fermentation vessel with at least one marking, up to which a dough needs to rise on the basis of the dough which is contained in the intermediate baking product having an ideal fermentation.

15. The baking set according to claim 14, wherein the flour at least partly surrounds the intermediate baking product in a thermally insulating manner.

16. The intermediate baking product according to claim 2, further comprising an outer packaging in which the dough with the membrane and the liquid is contained.

17. The intermediate baking product according to claim 16, wherein the outer packaging comprises information on further ingredients which need to be added, in order to create, from the dough as well as the membrane and liquid, a finished baking product dough for baking a baking product.

18. The intermediate baking product according to claim 17, wherein the outer packaging comprises a marking for measuring an additional amount of water to be added.
